(19) United States
(12) Patent Application Publication
(10) Pub. No.: US 2016/0210034 A1
(43) Pub. Date: Jul. 21, 2016

(54) METHOD AND APPARATUS FOR SWITCHING DISPLAY MODE

(71) Applicant: Xiaomi Inc., Beijing (CN)

(72) Inventors: Cai Zhu, Beijing (CN); Ying Wang, Beijing (CN); Bo Wang, Beijing (CN); Fei Xu, Beijing (CN)

(21) Appl. No.: 14/992,600

(22) Filed: Jan. 11, 2016

(30) Foreign Application Priority Data
Jan. 15, 2015 (CN) 201510019567.8

(51) Int. Cl. G06F 3/0484; G06T 3/40

(52) U.S. Cl. CPC G06F 3/04847; G06T 3/40; G06T 2200/24

(57) ABSTRACT

A method for switching a display mode of a screen of a mobile terminal, which has at least three buttons, includes detecting and obtaining an event of successively triggering at least two of the at least three buttons, obtaining a current display mode of the screen, and switching the display mode of the screen according to a trigger manner of the event and the current display mode.

### CROSS-REFERENCE TO RELATED APPLICATIONS

This application is based upon and claims priority to Chinese Patent Application No. 201510019567.8, filed on Jan. 15, 2015, the entire contents of which are incorporated herein by reference.

### TECHNICAL FIELD

The present disclosure relates to terminal technology and, more particularly, to a method and apparatus for switching a display mode.

### BACKGROUND

A user of a mobile terminal having a large screen, such as a 5.0-inch screen or a 5.7-inch screen, often finds it difficult to make an effective operation when holding the mobile terminal with a single hand. An approach to overcome this difficulty according to conventional technologies is to switch a display mode of the mobile terminal from a full screen mode to a single-hand operation mode. The single-hand operation mode at least includes a leftward scaling mode or a rightward scaling mode. Switching from the full screen mode to the single-hand operation mode can be accomplished using a gyroscope installed in the mobile terminal. For example, when the user shakes the mobile terminal, the gyroscope detects the shake operation, which triggers the switching of a current display mode from the full screen mode to the single-hand operation mode. Alternatively, a mode setting page can be provided and at least a first option and a second option can be included in the mode setting page. The first option is configured to switch from the full screen mode to the single-hand operation mode and the second option is configured to switch from the single-hand operation mode to the full screen mode. For example, when the selection of the first option is detected, the terminal switches the current display mode from the full screen mode to the single-hand operation mode.

### SUMMARY

In accordance with the present disclosure, there is provided a method for switching a display mode of a screen of a mobile terminal, which has at least three buttons. The method includes detecting and obtaining an event of successively triggering at least two of the at least three buttons, obtaining a current display mode of the screen, and switching the display mode of the screen according to a trigger manner of the event and the current display mode.

Also in accordance with the present disclosure, there is provided an apparatus for switching a display mode of a screen of a mobile terminal having at least three buttons. The apparatus includes a processor and a memory storing instructions. The instructions, when executed by the processor, cause the processor to detect and obtain an event of successively triggering at least two of the at least three buttons, obtain a current display mode of the screen, and switch the display mode of the screen according to a trigger manner of the event and the current display mode.

Also in accordance with the present disclosure, there is provided a non-transitory computer-readable storage medium having stored therein instructions. The instructions, when executed by a processor of a mobile terminal having at least three buttons, cause the mobile terminal to detect and obtain an event of successively triggering at least two of the at least three buttons, obtain a current display mode of a screen of the mobile terminal, and switch a display mode of the screen according to a trigger manner of the event and the current display mode.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for switching a display mode according to an exemplary embodiment.

FIG. 2 is a flow chart showing a method for switching a display mode according to another exemplary embodiment.

FIG. 3 is a schematic diagram illustrating a screen display according to an exemplary embodiment.

FIG. 4 is a schematic diagram illustrating a screen display according to another exemplary embodiment.

FIG. 5 is a schematic diagram illustrating a screen display according to another exemplary embodiment.

FIGS. 6(a) and 6(b) are schematic diagrams illustrating switching of a screen display from a full screen mode to a leftward scaling mode according to an exemplary embodiment.

FIGS. 7(a) and 7(b) are schematic diagrams illustrating switching of a screen display from the full screen mode to a rightward scaling mode according to an exemplary embodiment.

FIGS. 8(a) and 8(b) are schematic diagrams illustrating switching of a screen display from the leftward scaling mode to the full screen mode according to an exemplary embodiment.

FIGS. 9(a) and 9(b) are schematic diagrams illustrating switching of a screen display from the leftward scaling mode to the rightward scaling mode according to an exemplary embodiment.

FIGS. 10(a) and 10(b) are schematic diagrams illustrating switching of a screen display from the leftward scaling mode to the full screen mode according to another exemplary embodiment.

FIGS. 11(a) and 11(b) are schematic diagrams illustrating switching of a screen display from the rightward scaling mode to the leftward scaling mode according to an exemplary embodiment.

FIGS. 12(a) and 12(b) are schematic diagrams illustrating switching of a screen display from the rightward scaling mode to the full screen mode according to another exemplary embodiment.

FIGS. 13(a) and 13(b) are schematic diagrams illustrating switching of a screen display from the rightward scaling mode to the full screen mode according to another exemplary embodiment.

FIG. 14 is a block diagram illustrating an apparatus for switching a display mode according to an exemplary embodiment.

FIG. 15 is a schematic diagram of an apparatus for switching a display mode according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

FIG. 1 is a flow chart of a method 100 for switching a display mode according to an exemplary embodiment. The method 100 can be implemented in a mobile terminal. The mobile terminal has a screen and at least three buttons arranged in a display interface of the mobile terminal, e.g., a first button, a second button, and a third button arranged from left to right. In accordance with the present disclosure, the at least three buttons may be physical buttons or virtual buttons. As shown in FIG. 1, at S101, an event of successively triggering at least two of the buttons in the display interface is detected and obtained. Such an event is also referred to as a successive-trigger event. At S102, a current display mode of the screen is obtained. At S103, the display mode of the screen is switched according to the current display mode and a trigger manner of the successive-trigger event. The display mode includes a full screen mode, a leftward scaling mode, and a rightward scaling mode.

In some embodiments, to detect and obtain the successive-trigger event, i.e., in S101, a pre-registered listener is obtained and the successive-trigger event is detected and obtained based on the listener. For example, when the listener detects that any one of the at least three buttons is triggered, a first button parameter is obtained according to the listener, and a button corresponding to the first button parameter is obtained according to a correspondence between button parameters and buttons. If the obtained button is the second button, a timer is started to record an elapsed time since the starting of the timer. If a second button parameter is obtained before the elapsed time reaches a predetermined duration, it is determined that the successive-trigger event is obtained.

In some embodiments, to obtain the first button parameter according to the listener, an onKeyEvent function in the timer, a keyEvent function, and then a getKeyCode function are called when it is detected that any button is triggered. The first button parameter is obtained according to the getKeyCode function.

In some embodiments, obtaining the current display mode, i.e., in S102, includes obtaining a current mode parameter and obtaining the current display mode corresponding to the current mode parameter according to a correspondence between display modes and mode parameters. For example, the full screen mode, leftward scaling mode, and rightward scaling mode discussed above correspond to a first mode parameter, a second mode parameter, and a third mode parameter, respectively. Therefore, when the current mode parameter is the first mode parameter, the full screen mode is obtained as the current display mode. When the current mode parameter is the second mode parameter, the leftward scaling mode is obtained as the current display mode. When the current mode parameter is the third mode parameter, the rightward scaling mode is obtained as the current display mode.

In some embodiments, switching the display mode of the screen according to the trigger manner, i.e., in S103, includes determining the trigger manner of the at least two buttons as a continuous tap according to the successive-trigger event, and switching the display mode of the screen according to the continuous tap and the current display mode. For example, the continuous tap may be a left-sliding continuous tap or a right-sliding continuous tap. Consistent with the present disclosure, if triggered buttons include at least the first button and the second button, and a sliding path of a touch operation on the at least two buttons is towards left, then the trigger manner can be determined to be the left-sliding continuous tap. Similarly, if the triggered buttons include at least the third button and the second button, and the sliding path of the touch operation on the at least two buttons is towards right, then the trigger manner can be determined to be the right-sliding continuous tap.

Consistent with the present disclosure, the display mode of the screen can be switched from the current display mode to a different display mode according to a combination of the continuous tap and the current display mode. For example, if the continuous tap is a left-sliding continuous tap and the current display mode is the full screen mode, the full screen mode is switched to the leftward scaling mode. If the continuous tap is the right-sliding continuous tap and the current display mode is the full screen mode, the full screen mode is switched to the rightward scaling mode. If the continuous tap is the left-sliding continuous tap and the current display mode is the leftward scaling mode, the leftward scaling mode is switched to the full screen mode. If the continuous tap is the right-sliding continuous tap and the current display mode is the leftward scaling mode, the leftward scaling mode is switched to the rightward scaling mode or the full screen mode. If the continuous tap is the left-sliding continuous tap and the current display mode is the rightward scaling mode, the rightward scaling mode is switched to the leftward scaling mode or the full screen mode. If the continuous tap is the right-sliding continuous tap and the current display mode is the rightward scaling mode, the rightward scaling mode is switched to the full screen mode.

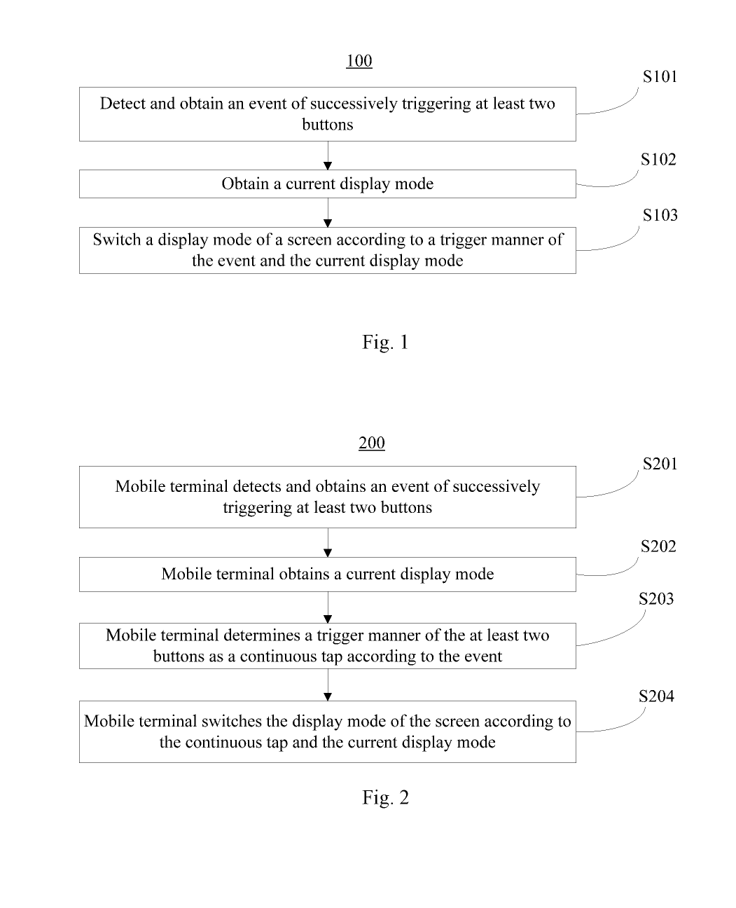

FIG. 2 is a flow chart showing a method 200 for switching a display mode according to another exemplary embodiment. The method 200 can be implemented in a mobile terminal. As shown in FIG. 2, at S201, the mobile terminal detects and obtains a successive-trigger event.

According to the present disclosure, the mobile terminal may be, for example, a mobile phone, a desktop computer, or a tablet personal computer having a touch screen. The mobile terminal at least has three buttons arranged in a lower portion of a display interface in such a manner that the three buttons are a first button, a second button, and a third button from left to right. For example, the first button is a Menu button, and a menu option may be popped up when the first button is triggered; the second button is a Home button, and a home page may be returned to when the second button is triggered; and the third button is a Back button, and a previous page or operation may be returned to when the third button is triggered.

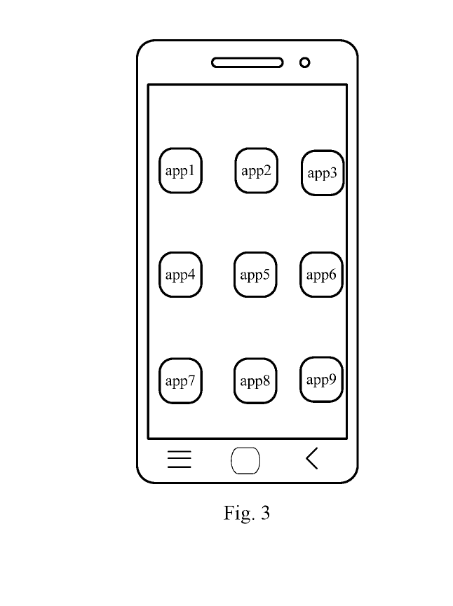

FIG. 3 schematically shows a screen display according to an exemplary embodiment. In the example shown in FIG. 3, three buttons are presented. The first button is represented by a symbol “ [symbol] ”, the second button is represented by a symbol “ [symbol] ”, and the third button is represented by a symbol “ [symbol] ”. As discussed above, these buttons of the mobile terminal can be physical buttons or virtual buttons. When the buttons of the mobile terminal are physical buttons, the three physical buttons will not disappear when the mobile terminal is turned off. When the buttons of the mobile terminal are virtual buttons, according to an attitude of the mobile terminal, which may be determined according to gravity, the three virtual buttons can be arranged in the lower portion of the display interface of the mobile terminal when the mobile terminal is powered on, and may disappear when the mobile terminal is powered off. In some embodiments, the virtual buttons may be hidden, and may be displayed when the user triggers a predetermined operation. In the example shown in FIG. 3, the three buttons are arranged laterally along a line. However, if the three buttons are virtual buttons, they can be arranged in a different manner. For example, if the three buttons are virtual buttons, they can be arranged according to the application current run on the mobile terminal.

In some embodiments, the mobile terminal may further include buttons having other functions in addition to the above-described three buttons. For example, the mobile terminal may have a search button, a button having a networking function, a button having a playing function, and so on. In actual applications, the mobile terminal may have four buttons, and the four buttons are arranged in the lower portion of the display interface of the mobile terminal in such a manner that the four buttons are the first button, the second button, the third button, and a fourth button from left to right, in which the first button is the Menu button, the second button is the Home button, the third button is the Back button, and the fourth button is a search button. A search dialog box may be popped up when the search button is triggered, and related content can be found through the search dialog box.

Thus, according to the present disclosure, with the help of the mobile terminal's own buttons, the display mode can be switched in different scenes. In order to provide the user with different display modes more accurately, the display mode is determined according to a touch operation on at least two buttons in the mobile terminal. Before this, the mobile terminal detects and obtains the successive-trigger event, as described below.

First, the mobile terminal obtains a pre-registered listener. The listener is a system having a monitoring/listening function in the mobile terminal. In some embodiments, the listener is mainly configured to monitor button-triggering events in the mobile terminal. Further, the listener includes a plurality of functions of different levels, such as a first-level function of onKeyEvent, a second-level function of KeyEvent, a third-level function of getKeyCode, and so on. The mobile terminal may register the listener with a setInputFilter method in an InputManagerService process, and can obtain the pre-registered listener from the InputManagerService process directly.

Next, the mobile terminal detects and obtains the successive-trigger event based on the listener. Based on the function of the listener, when it is detected that any button is triggered, the mobile terminal detects and obtains the successive-trigger event, as described in detail below.

(1) The mobile terminal calls the function onKeyEvent, then calls the function keyEvent under the function onKeyEvent, and finally calls the function getKeyCode under the function keyEvent. A first button parameter is obtained according to the function getKeyCode.

According to the present disclosure, different button parameters correspond to different buttons, and the button parameters may be pre-set by the user. For example, the button parameter of the Menu button may be set as 82, the button parameter of the Home button may be set as 3, and the button parameter of the Back button may be set as 4. Once the button parameters are set, they may not change in subsequent operations. After the button parameters of different buttons are set, a correspondence between different buttons and button parameters is formed. In order to facilitate subsequent applications, in some embodiments, the correspondence between buttons and button parameters is stored in a storage cell, such as a memory or a flash memory.

In addition, the first button parameter and the second button parameter are not meant to imply values of the button parameters, but only to distinguish different button parameters. That is, the first button parameter does not necessarily have a value larger than or smaller than the second button parameter. In practice, each of the first button parameter and the second button parameter may be any one of the above button parameters 3, 4, and 82. For example, a first button-triggering event and a second button-triggering event of the mobile terminal may have occurred, each of which corresponds to the triggering of one button. The first button parameter represents a button parameter obtained in the first button-triggering event, and the second button parameter represents a button parameter obtained in the second button-triggering event.

(2) A button corresponding to the first button parameter is obtained according to the correspondence between button parameters and buttons. If the obtained button is the second button, the mobile terminal starts a timer. That is, if the second button, for example, the Home button, is triggered in a first touch operation, the first touch operation is determined to be an effective operation as the first button-triggering event. At this time, the mobile terminal starts the timer for timing an elapsed time.

(3) If a second button parameter is obtained from the second button-triggering event before the elapsed time reaches a predetermined duration, the mobile terminal determines that the successive-trigger event is obtained.

In some embodiments, the predetermined duration is configured to represent a longest reaction time between two touch operations monitored by the listener. If no other button operation is detected before the elapsed time reaches the predetermined duration, an original logic of the second button is triggered and a corresponding operation is executed, and the obtained first button parameter is discarded. If another button operation is detected before the elapsed time reaches the predetermined duration, a button parameter of the other button operation is obtained using the method similar to that for obtaining the first button parameter. If the button corresponding to the obtained button parameter is the first button or the third button according to the correspondence between buttons and button parameters, the mobile terminal determines that the successive-trigger event is obtained. On the other hand, if the button corresponding to the obtained button parameter is the second button according to the correspondence between buttons and button parameters, the original logic of the second button is executed.

For example, the predetermined duration is set as 80 milliseconds, the button parameter of the Menu button is set as 82, the button parameter of the Home button is set as 3, and the button parameter of the Back button is set as 4. If a button operation on the Home button is detected and the timer is started, but no other button operation is detected before the elapsed time reaches 80 milliseconds, a logic of the Home button is triggered and the obtained first button parameter, i.e. 3, is discarded. If another button operation is detected before the elapsed time reaches 80 milliseconds, and the obtained button parameter of the button operation is 82, then from the correspondence between buttons and button parameters, the mobile terminal determines that the button corresponding to the button parameter is the Menu button, and that the successive-trigger event is obtained. If another button operation is detected before the elapsed time reaches 80 milliseconds, and the obtained button parameter of the button operation is 4, then from the correspondence between buttons and button parameters, the mobile terminal determines that the button corresponding to the button parameter is the Back button, and that the successive-trigger event is obtained. If another button operation is detected before the elapsed time reaches 80 milliseconds, and the obtained button parameter of the button operation is 3, then from the correspondence between buttons and button parameters, the mobile terminal determines that the button corresponding to the button parameter is again the Home button, and the original logic of the Home button is executed.

At S202, the mobile terminal obtains a current display mode. In some embodiments, the display mode includes a full screen mode, a leftward scaling mode, and a rightward scaling mode. When the user triggers the mobile terminal to perform a mode switching operation, it implies that the current display mode of the screen cannot satisfy the user's need, and it is required to switch the current display mode to a display mode satisfying the user's need. Thus, the current display mode should be obtained before switching the display mode.

In order to identify different display modes, in some embodiments, different display modes are assigned different codes. For example, the code corresponding to the full screen mode is MODE_NONE, the code corresponding to the leftward scaling mode is MODE_LEFT, and the code corresponding to the rightward scaling mode is MODE_RIGHT. Furthermore, different display modes correspond to different mode parameters. For example, the mode parameter corresponding to the full screen mode is a first parameter, the mode parameter corresponding to the leftward scaling mode is a second parameter, and the mode parameter corresponding to the rightward scaling mode is a third parameter. In some embodiments, the first parameter is set as 0, the second parameter is set as 1, and the third parameter is set as 2. In addition, the mobile terminal stores the mode parameter corresponding to the current display mode in memory during the operation thereof. Thus, to obtain the current display mode, the terminal may obtain the mode parameter representing the current display mode first, and then obtain the current display mode corresponding to the mode parameter from a correspondence between display modes and mode parameters.

For example, if the obtained mode parameter is the first parameter, i.e., if the code representing the current display mode obtained from the memory is “static final int MODE_NONE=0,” the current display mode corresponding to the first mode parameter is obtained as the full screen mode from the correspondence between display modes and mode parameters. If the obtained mode parameter is the second parameter, i.e., if the code representing the current display mode obtained from the memory is “static final int MODE_LEFT=1,” the current display mode corresponding to the second mode parameter is obtained as the leftward scaling mode from the correspondence between display modes and mode parameters. If the obtained mode parameter is the third parameter, i.e., if the code representing the current display mode obtained from the memory is “static final int MODE_RIGHT=2,” the current display mode corresponding to the third mode parameter is obtained as the rightward scaling mode from the correspondence between display modes and mode parameters.

At S203, the mobile terminal determines the trigger manner of the at least two buttons as a continuous tap according to the successive-trigger event. The continuous tap may be a left-sliding continuous tap or a right-sliding continuous tap.

For example, if triggered buttons include at least the first button and the second button, and a sliding path of a touch operation on the at least two buttons is towards left, the trigger manner of the at least two buttons is determined as the left-sliding continuous tap.

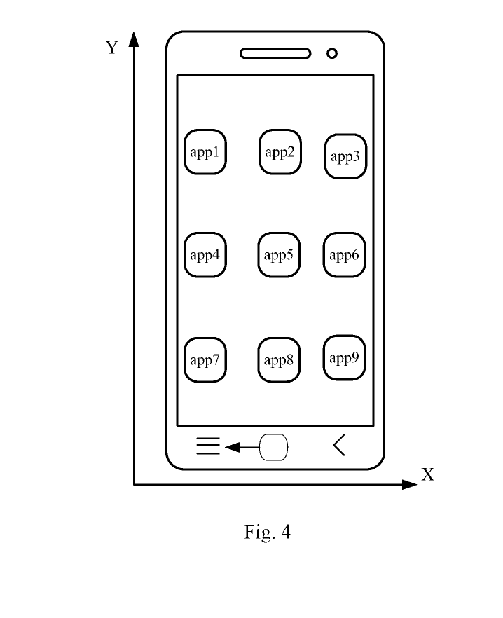

FIG. 4 schematically shows a screen display consistent with embodiments of the present disclosure. A coordinate system is illustrated in FIG. 4. In some embodiments, after the mobile terminal detects that the first button and the second button are triggered, a first coordinate of a position of the first button and a second coordinate of a position of the second button are obtained, and a first vector is obtained based on the first coordinate and the second coordinate. For example, the first vector can be a vector extending from the position of the second button to the position of the first button. If an angle between the first vector and a positive X-axis is an obtuse angle or a straight, i.e., 180° , angle, the sliding path of the touch operation on the first button and the second button is determined to be towards left, and the trigger manner of the at least two buttons is determined to be the left-sliding continuous tap.

As another example, if the triggered buttons include at least the third button and the second button, and the sliding path of the touch operation on the at least two buttons is towards right, the trigger manner of the at least two buttons is determined as the right-sliding continuous tap.

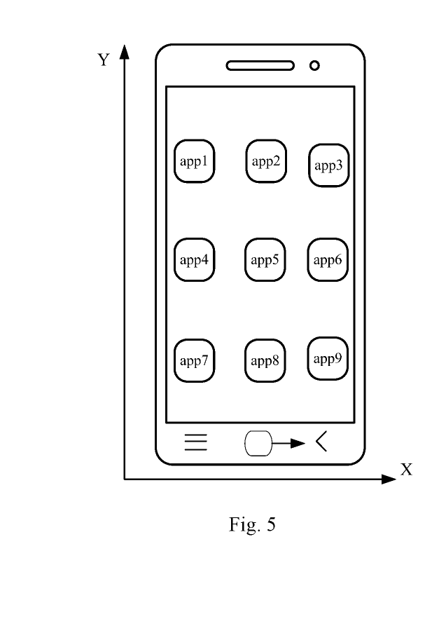

As shown in FIG. 5, after the mobile terminal detects that the third button and the second button are triggered, a third coordinate of a position of the third button and the second coordinate of the position of the second button are obtained, and a second vector is obtained based on the third coordinate and the second coordinate. For example, the second vector can be a vector extending from the position of the second button to the position of the third button. If an angle between the second vector and the positive X-axis is an acute angle, the sliding path of the touch operation on the third button and the second button is determined to be towards right, and the trigger manner of the at least two buttons is determined to be the right-sliding continuous tap.

The above-described exemplary methods are suitable for both the scenario in which the buttons are physical buttons and have fixed locations and the scenario in which the buttons are virtual buttons and can have different locations in different applications. In some embodiments, if the buttons are physical buttons, which have respective fixed coordinates of position, a simplified approach can be implemented. That is, the sliding path of a touch operation can be determined according to the timings at which the buttons are respectively triggered. For example, after the mobile terminal detects that the second button and the first button are successively triggered, since the first button is arrange on the left of the second button, the mobile terminal can determine that a left-sliding continuous tap has occurred.

In the exemplary methods described above, the sliding starts from the second button. In other embodiments, the sliding can start from another button, such as the first button, and the sliding path can also be determined in a manner similar to that described above.

In the embodiments described above, a mobile terminal having three buttons is illustrated as an example. Methods consistent with the present disclosure can also be implemented in a mobile terminal having a different number of buttons, a trigger manner of the buttons can be determined according to the successive-trigger event. For example, for a mobile terminal having four buttons, e.g., a first button, a second button, a third button, and a fourth button arranged from left to right, if it is detected that the first button and the second button are triggered and the sliding path of the touch operation on the first button and the second button is towards left, the trigger manner of the first button and the second button is determined to be the left-sliding continuous tap. If it is detected that the third button and the fourth button are triggered and the sliding path of the touch operation on the third button and the fourth button is towards right, the trigger manner of the third button and the fourth button is determined to be the right-sliding continuous tap.

Referring again to FIG. 2, at S204, the mobile terminal switches the display mode of the screen according to the continuous tap and the current display mode. That is, both the trigger manner of the at least two buttons and the current display mode affect switching the display mode of the mobile terminal.

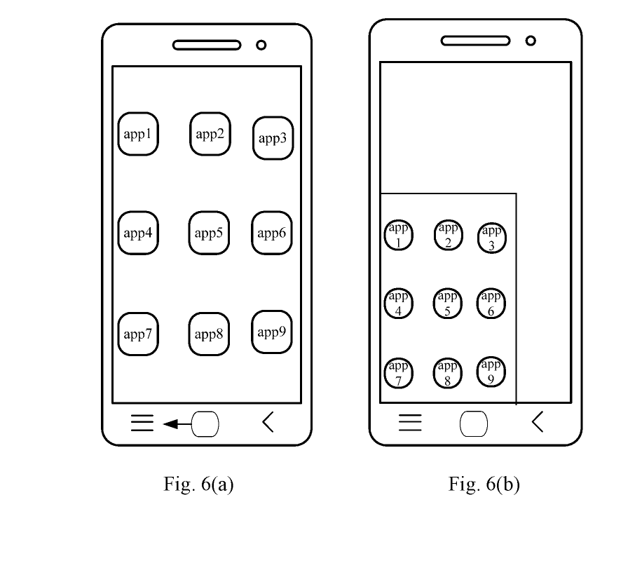

For example, if the continuous tap is the left-sliding continuous tap and the current display mode is the full screen mode, the full screen mode is switched to the leftward scaling mode. That is, when the mobile terminal is in the full screen mode and detects a continuous tap that is the left-sliding continuous tap, as shown in FIG. 6(a), it indicates that the user intends to operate the mobile terminal with his left hand. In order to satisfy the user's need, the mobile terminal switches from the full screen mode shown in FIG. 6(a) to the leftward scaling mode shown in FIG. 6(b).

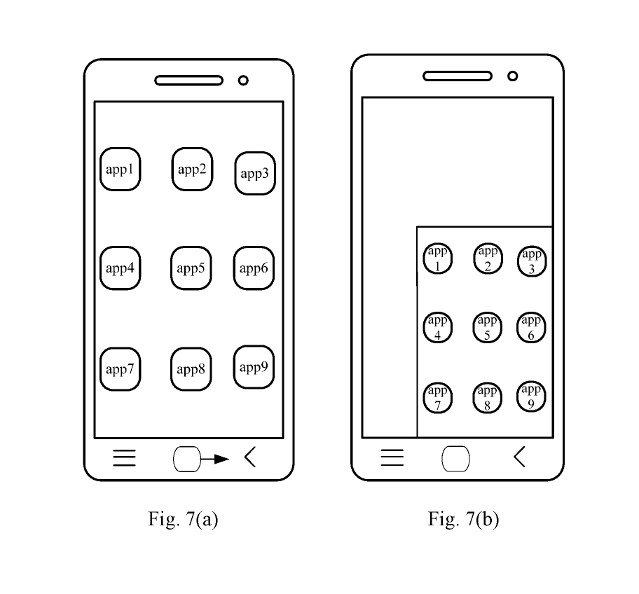

As another example, if the continuous tap is the right-sliding continuous tap and the current display mode is the full screen mode, the full screen mode is switched to the rightward scaling mode. That is, when the mobile terminal is in the full screen mode and detects a continuous tap that is the right-sliding continuous tap, as shown in FIG. 7(a), it indicates that the user intends to operate the mobile terminal with his right hand. In order to satisfy the user's need, the mobile terminal switches from the full screen mode shown in FIG. 7(a) to the rightward scaling mode shown in FIG. 7(b).

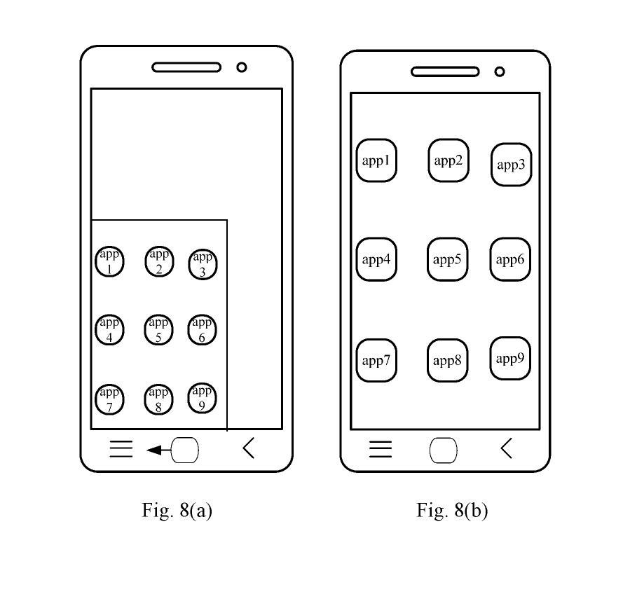

As another example, if the continuous tap is the left-sliding continuous tap and the current display mode is the leftward scaling mode, the leftward scaling mode is switched to the full screen mode. That is, when the mobile terminal is in the leftward scaling mode and detects a continuous tap that is the left-sliding continuous tap, as shown in FIG. 8(a), the mobile terminal switches from the leftward scaling mode shown in FIG. 8(a) to the full screen mode shown in FIG. 8(b).

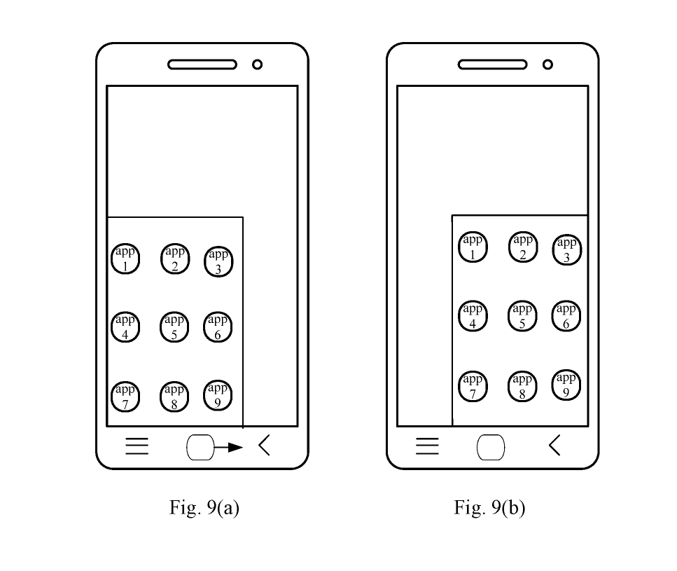

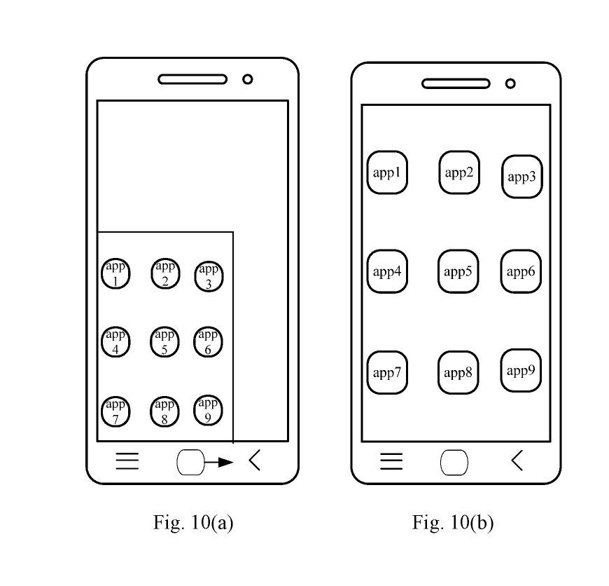

As another example, if the continuous tap is the right-sliding continuous tap and the current display mode is the leftward scaling mode, the leftward scaling mode is switched to the rightward scaling mode or the full screen mode. That is, when the mobile terminal is in the leftward scaling mode and detects a continuous tap that is the right-sliding continuous tap, as shown in FIG. 9(a) or FIG. 10(a), the mobile terminal switches from the leftward scaling mode to the rightward scaling mode shown in FIG. 9(b) or the full screen mode shown in FIG. 10(b). Whether to switch to the rightward scaling mode or the full screen mode may depend on an angle between the sliding path of the touch operation and a positive direction of a longitudinal axis of the mobile terminal. For example, when a successive-trigger event is detected in a predetermined area of the current screen and an angle between the sliding path and the positive direction of the longitudinal axis is greater than a predetermined angle value, the leftward scaling mode is switched to the rightward scaling mode shown in FIG. 9(b). Alternatively, when the angle between the sliding path and the positive direction of the longitudinal axis is less than the predetermined angle value, the leftward scaling mode is switched to the full screen mode shown in FIG. 10(b).

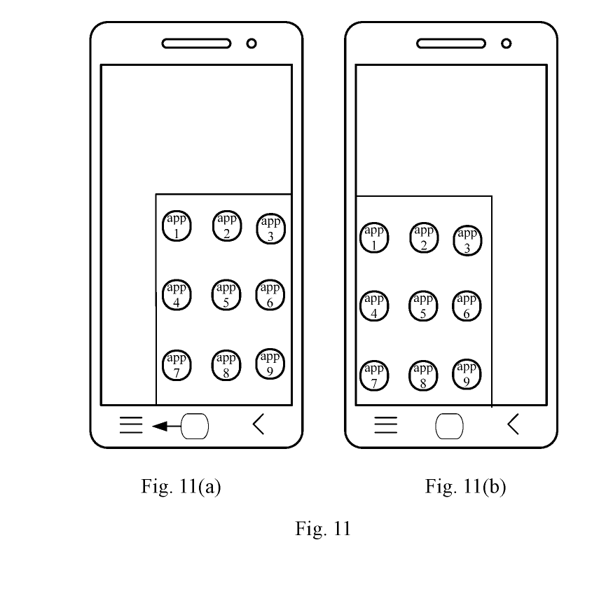

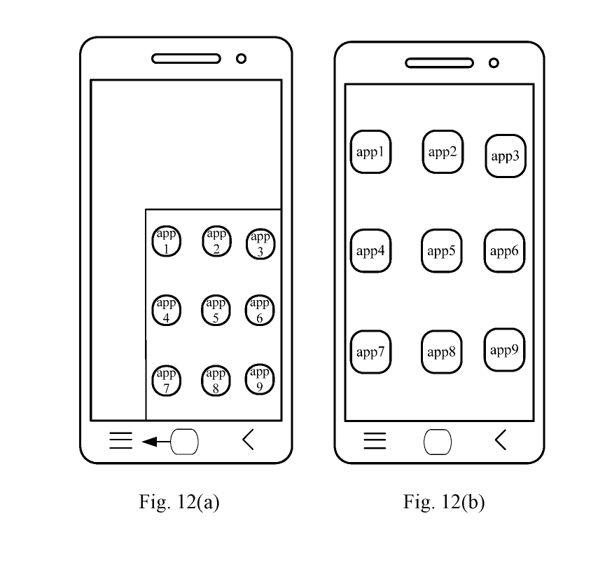

As another example, if the continuous tap is the left-sliding continuous tap and the current display mode is the rightward scaling mode, the rightward scaling mode is switched to the leftward scaling mode or the full screen mode. That is, when the mobile terminal is in the rightward scaling mode and detects a continuous tap that is the left-sliding continuous tap, as shown in FIG. 11(a) or FIG. 12(a), the mobile terminal switches from the rightward scaling mode to the leftward scaling mode shown in FIG. 11(b) or the full screen mode shown in FIG. 12(b). Whether to switch to leftward scaling mode or the full screen mode may depend on an angle between the sliding path of the touch operation and a positive direction of a longitudinal axis of the mobile terminal. For example, if the angle between the sliding path of the touch operation and the positive direction of the longitudinal axis of the mobile terminal is greater than a predetermined angle value, the mobile terminal switches from the rightward scaling mode shown in FIG. 11(a) to the leftward scaling mode shown in FIG. 11(b). Alternatively, if the angle between the sliding path of the touch operation and the positive direction of the longitudinal axis of the mobile terminal is less than the predetermined angle value, the mobile terminal switches from the rightward scaling mode shown in FIG. 12(a) to the full screen mode shown in FIG. 12(b).

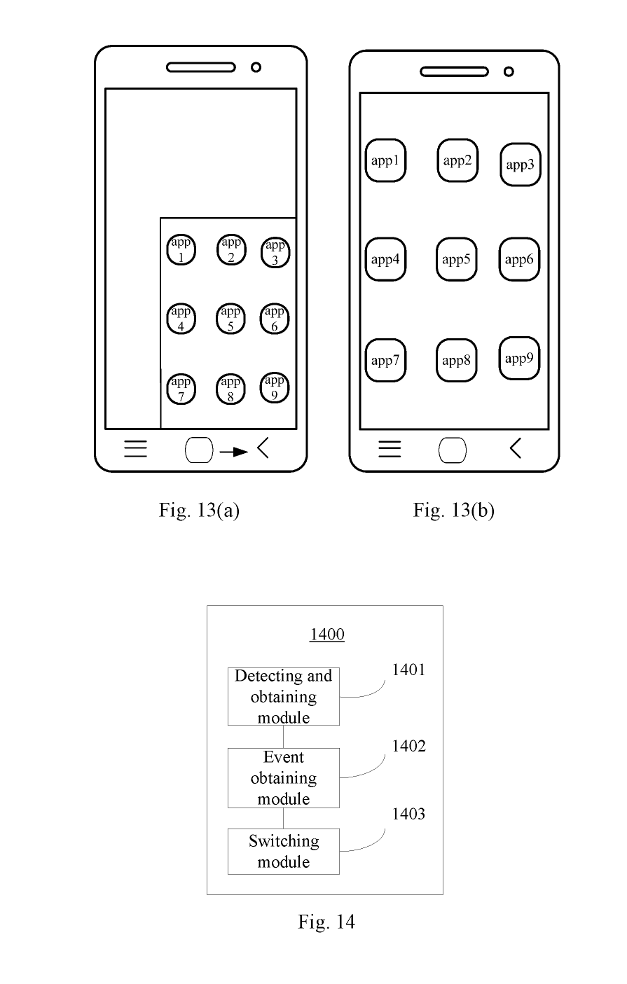

As another example, if the continuous tap is the right-sliding continuous tap and the current display mode is the rightward scaling mode, the rightward scaling mode is switched to the full screen mode. That is, when the mobile terminal is in the rightward scaling mode, such as a lower-right corner scaling mode, and detects a continuous tap that is the right-sliding continuous tap, as shown in FIG. 13(a), the mobile terminal switches from the rightward scaling mode to the full screen mode shown in FIG. 13(b).

FIG. 14 is a block diagram illustrating an apparatus 1400 for switching a display mode according to an exemplary embodiment. The apparatus 1400 can be implemented, for example, in a mobile terminal having at least three buttons arranged in a display interface of the mobile terminal in such a manner that the three buttons are a first button, a second button and a third button from left to right. As shown in FIG. 14, the apparatus 1400 includes a detecting and obtaining module 1401, an event obtaining module 1402, and a switching module 1403.

The detecting and obtaining module 1401 is configured to detect and obtain an successive-trigger event. The event obtaining module 1402 is configured to obtain a current display mode of a screen of the mobile terminal. The switching module 1403 is configured to switch the display mode of the screen according to a trigger manner of the successive-trigger event and the current display mode. The display mode includes a full screen mode, a leftward scaling mode, and a rightward scaling mode.

In some embodiments, the detecting and obtaining module 1401 includes a listener obtaining unit and an event detecting and obtaining unit. The listener obtaining unit is configured to obtain a pre-registered listener, which is a system having a monitoring/listening function, as described above, to determine whether a button is triggered. The event detecting and obtaining unit is configured to detect and obtain the successive-trigger event based on the listener.

In some embodiments, the event detecting and obtaining unit includes a first obtaining sub-unit, a second obtaining sub-unit, a starting sub-unit, and a determining sub-unit. The first obtaining sub-unit is configured to obtain a first button parameter according to the listener when the listener detects that any button is triggered. The second obtaining sub-unit is configured to obtain a button corresponding to the first button parameter according to a correspondence between button parameters and buttons. The starting sub-unit is configured to start a timer to record an elapsed time since the starting of the timer if the obtained button is the second button. The determining sub-unit is configured to determine that the successive-trigger event obtained, if a second button parameter is obtained before the elapsed time reaches a predetermined duration.

In some embodiments, the first obtaining sub-unit is configured to call an onKeyEvent function in the timer, a keyEvent function, and a getKeyCode function when it is detected that any button is triggered, and to obtain the first button parameter according to the getKeyCode function.

In some embodiments, the event obtaining module 1402 is configured to obtain a current mode parameter and to obtain the current display mode corresponding to the current mode parameter according to a correspondence between display modes and mode parameters. For example, the full screen mode, leftward scaling mode, and rightward scaling mode discussed above correspond to a first mode parameter, a second mode parameter, and a third mode parameter, respectively. Therefore, when the obtained current mode parameter is the first mode parameter, the event obtaining module 1402 obtains the full screen mode as the current display mode. When the obtained current mode parameter is the second mode parameter, the event obtaining module 1402 obtains the leftward scaling mode as the current display mode. When the obtained current mode parameter is the third mode parameter, the event obtaining module 1402 obtains the rightward scaling mode as the current display mode.

In some embodiments, the switching module 1403 includes a determining unit and a switching unit. The determining unit is configured to determine the trigger manner of the at least two buttons as a continuous tap according to the successive-trigger event. The switching unit is configured to switch the display mode of the screen according to the continuous tap and the current display mode.

In some embodiments, the continuous tap may be a left-sliding continuous tap or a right-sliding continuous tap. Consistent with the present disclosure, if triggered buttons include at least the first button and the second button, and a sliding path of a touch operation on the at least two buttons is towards left, then the determining unit determines that the trigger manner is the left-sliding continuous tap. Similarly, if the triggered buttons include at least the third button and the second button, and the sliding path of the touch operation on the at least two buttons is towards right, the determining unit determines that the trigger manner is the the right-sliding continuous tap.

Thus, if the continuous tap is the left-sliding continuous tap and the current display mode is the full screen mode, the switching unit switches the display mode of the screen from the full screen mode to the leftward scaling mode. If the continuous tap is the right-sliding continuous tap and the current display mode is the full screen mode, the switching unit switches the display mode of the screen from the full screen mode to the rightward scaling mode. If the continuous tap is the right-sliding continuous tap and the current display mode is the leftward scaling mode, the switching unit switches the display mode of the screen from the leftward scaling mode to the rightward scaling mode or the full screen mode. If the continuous tap is the left-sliding continuous tap and the current display mode is the rightward scaling mode, the switching unit switches the display mode of the screen from the rightward scaling mode to the leftward scaling mode or the full screen mode. If the continuous tap is the right-sliding continuous tap and the current display mode is the rightward scaling mode, the switching unit switches the display mode of the screen from the rightward scaling mode to the full screen mode. If the continuous tap is the left-sliding continuous tap and the current display mode is the leftward scaling mode, the switching unit switches the display mode of the screen from the leftward scaling mode to the full screen mode.

With respect to the apparatuses in the above embodiments, the specific manners for performing operations for individual modules therein have been described in detail in the embodiments regarding the methods for switching the display mode, which will not be elaborated herein.

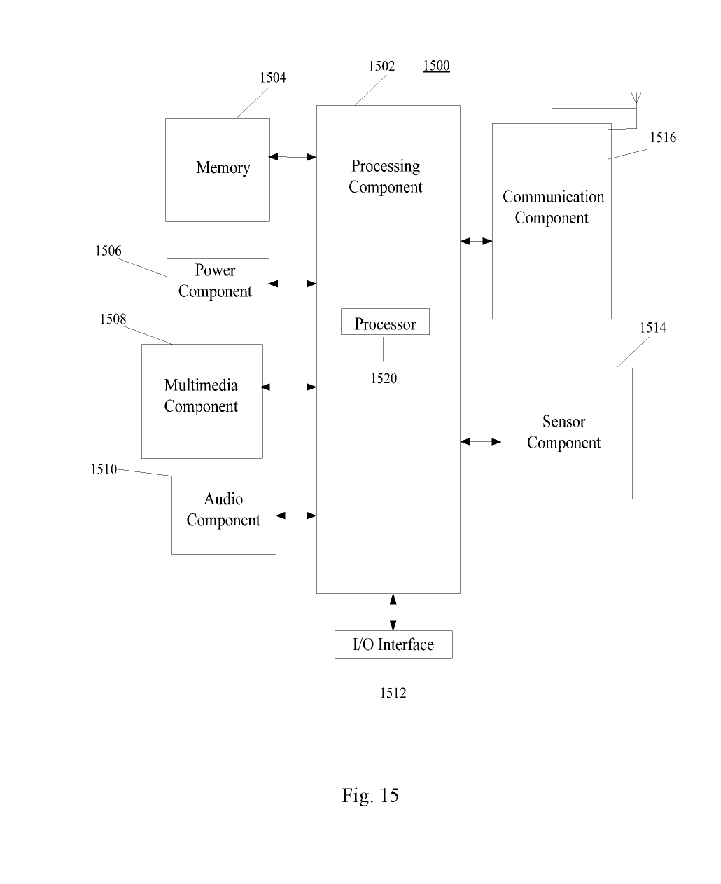

FIG. 15 is a schematic diagram of an apparatus 1500 for switching a display mode according to an exemplary embodiment. For example, the device 1500 may be a mobile phone, a computer, a digital broadcast terminal, a messaging device, a gaming console, a tablet, a medical device, an exercise equipment, a personal digital assistant, or the like.

Referring to FIG. 15, the apparatus 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls overall operations of the apparatus 1500, such as the operations associated with display, telephone calls, data communications, camera operations, and recording operations. The processing component 1502 may include one or more processors 1520 to execute instructions to perform all or part of the steps in the above described methods. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the apparatus 1500. Examples of such data include instructions for any applications or methods operated on the apparatus 1500, contact data, phonebook data, messages, pictures, video, etc. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the apparatus 1500. The power component 1506 may include a power management system, one or more power sources, and any other components associated with the generation, management, and distribution of power in the apparatus 1500.

The multimedia component 1508 includes a screen providing an output interface between the apparatus 1500 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and the rear camera may receive an external multimedia datum while the apparatus 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone configured to receive an external audio signal when the apparatus 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the apparatus 1500. For instance, the sensor component 1514 may detect an open/closed status of the apparatus 1500, relative positioning of components, e.g., the display and the keypad, of the apparatus 1500, a change in position of the apparatus 1500 or a component of the apparatus 1500, a presence or absence of user contact with the apparatus 1500, an orientation or an acceleration/deceleration of the apparatus 1500, and a change in temperature of the apparatus 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor.

The communication component 1516 is configured to facilitate communication, wired or wirelessly, between the apparatus 1500 and other devices. The apparatus 1500 can access a wireless network based on a communication standard, such as WiFi, 3G or 4G or a combination thereof. In one exemplary embodiment, the communication component 1516 receives a broadcast signal or broadcast associated information from an external broadcast management system via a broadcast channel. In one exemplary embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1504, executable by the processor 1520 in the apparatus 1500, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium is also provided, which stores instructions that, when executed by a processor of a terminal, causes the terminal to perform a method for switching a display mode consistent with embodiments of the present disclosure, such as described above. The terminal may be, for example, a mobile terminal.

According to the present disclosure, since the display mode is switched according to different manners or ways of triggering the terminal's own buttons and the current display mode, the operation is less complex and the switching between different display modes is easier. Moreover, methods and apparatuses consistent with the present disclosure are suitable for both left-handed and right-handed users.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for switching a display mode of a screen of a mobile terminal having at least three buttons, the method comprising:
detecting and obtaining an event of successively triggering at least two of the at least three buttons;
obtaining a current display mode of the screen; and
switching the display mode of the screen according to a trigger manner of the event and the current display mode.

2. The method according to claim 1, wherein detecting and obtaining the event includes:
obtaining a pre-registered listener configured to monitor triggering of one or more of the at least three buttons; and
detecting and obtaining the event based on the listener.

3. The method according to claim 2, wherein detecting and obtaining the event based on the listener includes:
obtaining a first button parameter according to the listener when a button triggering is detected;
obtaining a button corresponding to the first button parameter according to a correspondence between button parameters and buttons;
starting a timer to record an elapsed time since the timer is started; and
determining that the event is obtained, if a second button parameter is obtained before the elapsed time reaches a predetermined duration.

4. The method according to claim 3, wherein obtaining the first button parameter according to the listener includes:
calling an onKeyEvent function in the timer, a keyEvent function, and a getKeyCode function; and
obtaining the first button parameter according to the getKeyCode function.

5. The method according to claim 1, wherein obtaining the current display mode includes:
obtaining a current mode parameter; and
obtaining the current display mode corresponding to the current mode parameter according to a correspondence between display modes and mode parameters.

6. The method according to claim 5, wherein:
the correspondence between display modes and mode parameters includes a first correspondence between a full screen mode and a first parameter, a second correspondence between a leftward scaling mode and a second parameter, and a third correspondence between a rightward scaling mode and a third parameter, and obtaining the current display mode corresponding to the current mode parameter includes:
obtaining, if the current mode parameter is the first parameter, the full screen mode as the current display mode;
obtaining, if the current mode parameter is the second parameter, the leftward scaling mode as the current display mode; or
obtaining, if the current mode parameter is the third parameter, the rightward scaling mode as the current display mode.

7. The method according to claim 1, wherein switching the display mode includes:
determining the trigger manner as a continuous tap according to the event; and
switching the display mode of the screen according to the continuous tap and the current display mode.

8. The method according to claim 7, wherein:
the continuous tap includes a left-sliding continuous tap or a right-sliding continuous tap; and
determining the trigger manner includes:
determining the left-sliding continuous tap as the trigger manner if at least a first one of the at least three buttons and a second one of the at least three buttons are triggered and a sliding path of a touch operation on the first one and second one of the at least three buttons is towards left; or
determining the right-sliding continuous tap as the trigger manner if at least a third one of the at least three buttons and the second one of the at least three buttons are triggered and a sliding path of a touch operation on the third one and the second one of the at least three buttons is towards right.

9. The method according to claim 8, wherein switching the display mode of the screen according to the continuous tap and the current display mode includes:
switching, if the current display mode is a full screen mode and the continuous tap is the left-sliding continuous tap, the display mode from the full screen mode to a leftward scaling mode;
switching, if the current display mode is the full screen mode and the continuous tap is the right-sliding continuous tap, the display mode from the full screen mode to a rightward scaling mode;
switching, if the current display mode is the leftward scaling mode and the continuous tap is the left-sliding continuous tap, the display mode from the leftward scaling mode to the full screen mode;
switching, if the current display mode is the leftward scaling mode and the continuous tap is the right-sliding continuous tap, the display mode from the leftward scaling mode to the rightward scaling mode or the full screen mode;
switching, if the current display mode is the rightward scaling mode and the continuous tap is the left-sliding continuous tap, the display mode from the rightward scaling mode to the leftward scaling mode or the full screen mode; or
switching, if the current display mode is the rightward scaling mode and the continuous tap is the right-sliding continuous tap, the display mode from the rightward scaling mode to the full screen mode.

10. An apparatus for switching a display mode of a screen of a mobile terminal having at least three buttons, the apparatus comprising:
a processor; and
a memory storing instructions that, when executed by the processor, cause the processor to:
detect and obtain an event of successively triggering at least two of the at least three buttons;
obtain a current display mode of the screen; and
switch the display mode of the screen according to a trigger manner of the event and the current display mode.

11. The apparatus according to claim 10, wherein the instructions further cause the processor to:
obtain a pre-registered listener configured to monitor triggering of one or more of the at least three buttons; and
detect and obtain the event based on the listener.

12. The apparatus according to claim 11, wherein the instructions further cause the processor to:
obtain a first button parameter according to the listener when a button triggering is detected;
obtain a button corresponding to the first button parameter according to a correspondence between button parameters and buttons;
start a timer to record an elapsed time since the timer is started; and
determine that the event is obtained, if a second button parameter is obtained before the elapsed time reaches a predetermined duration.

13. The apparatus according to claim 12, wherein the instructions further cause the processor to:
call an onKeyEvent function in the timer, a keyEvent function, and a getKeyCode function; and
obtain the first button parameter according to the getKeyCode function.

14. The apparatus according to claim 10, the instructions further cause the processor to:
obtain a current mode parameter;
obtain the current display mode corresponding to the current mode parameter according to a correspondence between display modes and mode parameters.

15. The apparatus according to claim 14, wherein:
the correspondence between display modes and mode parameters includes a first correspondence between a full screen mode and a first parameter, a second correspondence between a leftward scaling mode and a second parameter, and a third correspondence between a rightward scaling mode and a third parameter, and
the instructions further cause the processor to:
obtain, if the current mode parameter is the first parameter, the full screen mode as the current display mode;
obtain, if the current mode parameter is the second parameter, the leftward scaling mode as the current display mode; or
obtain, if the current mode parameter is the third parameter, the rightward scaling mode as the current display mode.

16. The apparatus according to claim 10, wherein the instructions further cause the processor to:
determine the trigger manner as a continuous tap according to the event; and
switch the display mode of the screen according to the continuous tap and the current display mode.

17. The apparatus according to claim 16, wherein:
the continuous tap mode includes a left-sliding continuous tap or a right-sliding continuous tap, and
the instructions further cause the processor to:
determine the left-sliding continuous tap as the trigger manner if at least a first one of the at least three buttons and a second one of the at least three buttons are triggered and a sliding path of a touch operation on the first one and second one of the at least three buttons is towards left; or
determine the right-sliding continuous tap as the trigger manner if at least a third one of the at least three buttons and the second one of the at least three buttons are triggered and a sliding path of a touch operation on the third one and the second one of the at least three buttons is towards right.

18. The apparatus according to claim 17, wherein the instructions further cause the processor to:
switch, if the current display mode is a full screen mode and the continuous tap is the left-sliding continuous tap, the display mode from the full screen mode to a leftward scaling mode;
switch, if the current display mode is the full screen mode and the continuous tap is the right-sliding continuous tap, the display mode from the full screen mode to a rightward scaling mode;
switch, if the current display mode is the leftward scaling mode and the continuous tap is the left-sliding continuous tap, the display mode from the leftward scaling mode to the full screen mode;
switch, if the current display mode is the leftward scaling mode and the continuous tap is the right-sliding continuous tap, the display mode from the leftward scaling mode to the rightward scaling mode or the full screen mode;
switch, if the current display mode is the rightward scaling mode and the continuous tap is the left-sliding continuous tap, the display mode from the rightward scaling mode to the leftward scaling mode or the full screen mode; or
switch, if the current display mode is the rightward scaling mode and the continuous tap is the right-sliding continuous tap, the display mode from the rightward scaling mode to the full screen mode.

19. A non-transitory computer-readable storage medium having stored therein instructions that, when executed by a processor of a mobile terminal having at least three buttons, cause the mobile terminal to:
detect and obtain an event of successively triggering at least two of the at least three buttons;
obtain a current display mode of a screen of the mobile terminal; and
switch a display mode of the screen according to a trigger manner of the event and the current display mode.
